(19) United States
(12) Patent Application Publication
(10) Pub. No.: US 2022/0402439 A1
(43) Pub. Date: Dec. 22, 2022

(54) VEHICLE TAILGATE ASSEMBLY FOR RETAINING FISHING RODS AND ACCESSORIES

(71) Applicant: Jackey L. Overby, Grants Pass, OR (US)

(72) Inventor: Jackey L. Overby, Grants Pass, OR (US)

(21) Appl. No.: 17/743,755

(22) Filed: May 13, 2022

Related U.S. Application Data
(60) Provisional application No. 63/213,353, filed on Jun. 22, 2021.

(51) Int. Cl. B60R 9/08; A01K 97/10

(52) U.S. Cl. CPC B60R 9/08; A01K 97/10

(57) ABSTRACT

A vehicle tailgate assembly for retaining fishing rods and tailgate accessories detachably couples to the rear of a vehicle while retaining fishing rods and other tailgate-related accessories. The assembly comprises a swiveling hitch, multiple length adjustable extension bars, an adjustable table, a pivoting pole holder attachment, multiple detachable cup holders formed in table, a height adjustable leg, a detachable umbrella holder attachment and a width adjustable tee bar with one or more pivotable pole holder attachments. The assembly couples to the rear of vehicle through the swiveling hitch. The swiveling hitch enables rotation of the table and pole holder attachment. Length adjustable extensions are easily added and removed along the length of the assembly for length adjustments to vary the lateral separation distance between the rear of the vehicle and the table and pole holder attachment.

### CROSS-REFERENCE TO RELATED APPLICATIONS

This application claims priority from U.S. Provisional Application Ser. No. 63/213,353, entitled “Vehicle Tailgate Assembly for Retaining Fishing Rods and Accessories”, filed on Jun. 22, 2021, which application is hereby incorporated herein by reference in its entirety.

### FIELD OF THE INVENTION

The present invention relates generally to a vehicle assembly. More so, the present invention relates to a vehicle tailgate assembly for retaining fishing rods and tailgate accessories.

### BACKGROUND OF THE INVENTION

The following background information may present examples of specific aspects of the prior art (e.g., without limitation, approaches, facts, or common wisdom) that, while expected to be helpful to provide additional aspects of the prior art, is not to be construed as limiting the present invention, or any embodiments thereof, to anything stated or implied therein or inferred thereupon.

A motor vehicle is often used for supporting food, beverage, party, picnic, fishing, or other social related items. This activity is commonly referred to as picnicking or tailgating.

Typically, a tailgate also called a tailboard, is generally attached to the rear of a vehicle have been popular for many years. Such tailgates have been provided to a passenger or cargo compartment, such as a rear door on a station wagon, minivan, or SUV. Tailgates have also been provided on the rear end of cargo compartments, such as a bed of a pick-up truck.

For a tailgate party, it may be desirable to have more tabletop space than that could be provided by the tailgate itself. Also, for general eating, writing, and resting capabilities, a raised platform on the tailgate may be a useful accessory for such vehicles.

Numerous attempts have been made and several prior art devices are known for variety of reminder systems and devices. Even though these innovations may be suitable for the specific purposes to which they address, however, they would not be as suitable for the purposes of the present invention.

For example, U.S. Pat. No. 9,914,402 to Jones et al. discloses a rod & reel carrier and utility box assembly for a full-sized pickup bed, which is able to secure multiple rod and reels for transport, combined with a storage utility box with locking, hinged cover for storing fishing accessories.

U.S. Pat. No. 9,840,206 to Bales et al. relates to a utility board that may be securely attached to a tailgate comprising a cutting board, a channel for collecting fluids, a rinsing device, electrical outlets, one or more heating elements, one or more utensil holders, and/or accessories for use in recreational activities such as playing games.

U.S. Pat. No. 10,358,072 to Wereski describes a retractable tailgate adjustable table that can be retracted for stowage or folded out from the tailgate for operational usage from the tailgate.

U.S. Pat. No. 10,059,407 to Ingalls et al. discloses a watercraft seat mount assembly including a base portion, a seat portion. An accessory mount segment may be carried by the base portion for mounting the canopy assembly.

For example, U.S. Pat. Application No. 2006/0152029 to Tomasson et al. teaches a passenger vehicle having a multi-position tailgate comprising a retractable table.

U.S. Pat. Application No. 2007/0187447 to Hamann describes an improved hitch assembly is described for mounting accessories while simultaneously towing a trailer.

U.S. Pat. No. 5,033,223 to Minter discloses a holder comprising a bracket and a tube for holding fishing rods that may be removably mounted on a motor vehicle to support fishing rods.

U.S. Pat. No. 5,205,446 to Greenberg teaches a fishing pole holder for attachment to a vehicle hitch receptacle. The holder comprises a plurality of tubes configured for receiving the handles of the fishing poles therein.

U.S. Pat. No. 5,815,976 to Jernigan et al. relates to a fishing rod holder comprising a connector plate that connects directly to the bumper of a vehicle. The connector plate includes a series of sleeve holders to hold a plurality of fishing rod sleeves.

U.S. Pat. No. 5,857,741 to Anderson describes a vehicle trailer hitch mounted table and chairs which can be used for tailgate parties. The seats on the chairs swivel, and the table includes a dismountable umbrella.

U.S. Pat. No. 6,808,231 to Hill discloses a seat assembly releasably mounted to a vehicle trailer hitch, wherein the assembly includes a chair assembly and a footrest assembly.

U.S. Pat. No. 7,090,104 to Dorety teaches a height adjustable combination table and support member assembly for use in connection with a trailer hitch mounted onto a vehicle.

U.S. Design Pat. No. D458878 to Greco depicts a design of a trailer hitch fishing pole holder.

U.S. Design Pat. No. D643358 to McDonald illustrates a design of a fishing rod holder.

It is apparent now that numerous innovations that are adapted to a variety of vehicle tailgate assembly or fishing pole holder have been developed in the prior art that are adequate for various purposes. Furthermore, even though these innovations may be suitable for the specific purposes to which they address, accordingly, they would not be suitable for the purposes of the present invention as heretofore described. Thus, an easily mountable, adjustable, and foldable vehicle tailgate assembly that is configured to retain fishing poles, cups, bottle, umbrellas, and an adjustable table in variable positions from the rear of a vehicle is needed.

### SUMMARY OF THE INVENTION

The present invention relates generally to a vehicle tailgate assembly for retaining fishing rods and tailgate accessories. More so, the present invention relates to a tailgate assembly that includes: a swiveling hitch, multiple length adjustable extension bars, a table, a height adjustable leg, multiple pivoting fishing rods holders, multiple cup holders, and an umbrella holder attachment; whereby the tailgate assembly is operational while coupled to the rear of a vehicle through the swiveling hitch that enables axial rotation of the extension bars, while the extension bars enables variance of the lateral separation distance between the rear of the vehicle and the tailgate when in use, or transport, for sufficient distance to utilize the vehicle tailgate, or the rear door/hatchback of the vehicle.

According to yet another aspect of the present invention, a vehicle tailgate assembly for retaining fishing rods and tailgate accessories comprises: a swiveling hitch adapted for detachably coupling to a vehicle hitch receiver of a vehicle, the swiveling hitch comprising a first end and a second end, the first end forming a hitch hole configured to enable passage of a fastening pin, whereby the swiveling hitch detachably attaches to the vehicle receiver hitch, the swiveling hitch further comprising a hitch plate joined to the second end, the swiveling hitch further comprising a pair of swivel plates rotatably joined with the hitch plate at the second end of the swiveling hitch, the swivel plate is adjustable along a vertical plane; a first extension bar joined to the pair of swivel plates, the first extension bar having a pair of free ends that form a receiving aperture and a pair of lanyard eyes; at least one supplementary extension bar joined to the first extension bar, or to an adjoining supplementary extension bar, in a collinear relationship, the at least one supplementary extension bar having a pair of free ends, one of the free ends forming a receiving aperture and a pair of lanyard eyes forming a tab projecting therefrom, the tab being sized and dimensioned to mate with the receiving aperture of the first extension bar, wherein an opposing free end to receive another supplementary extension bar; a tee bar joined to the supplementary extension bar, in an orthogonal relationship, the tee bar defined by a horizontal axis and having a pair of free ends, the tee bar further having a central tab projecting from a midpoint there along; a pair of pole holder plates joined to the free ends of the tee bar; a pole holder attachment detachably coupled to each pole holder plate, the pole holder attachment configured to retain one or more poles and pivot about the horizontal axis of the tee bar; and a table joined to the at least one supplementary extension bar, the table having a top surface defining a linear measurement indicia and a bottom surface defining fastening holes, the table defining multiple accessory retention holes; a cup holder configured to removably fit into at least one of the accessory retention holes; an umbrella holder configured to removably attach to extensions; a height adjustable leg comprising a first section and a second section arranged in a telescopic relationship, each section having leg retention holes, whereby aligning the leg retention holes to receive a pin helps fasten the height adjustable leg at a desired length, further the leg comprises a stabilizer to stabilize the assembly on ground at a desired height, whereby the addition and removal of the at least one supplementary extension bar enables variance in the lateral separation distance between the rear of the vehicle and the table, whereby the pivotable configuration of the pole holder attachment enables the pole to pivot up to 90 degrees, whereby the addition and removal of the at least one supplementary extension bar, enables variance in the lateral separation distance between the rear of the vehicle and the pole holder attachment.

In another aspect, the assembly comprises multiple lanyards riveted in place at various locations to retain the pull ring detention pins.

In another aspect, the pole comprises a fishing pole.

In another aspect, the assembly is substantially fabricated from anodized aluminum.

In another aspect, the linear measurement indicium comprises a 24″ ruler.

In another aspect, the top surface of the table comprises a logo.

In another aspect, the umbrella holder comprises a square tube and a cylinder welded together.

In another aspect, the assembly further comprises a lanyard pin operable to pass through the lanyard eyes for fastening the first extension bar.

In another aspect, a long coupler is configured to join a pair of supplemental extensions bars.

One objective of the present invention is to provide a multipurpose tailgating assembly configured to retain fishing poles, cups, bottle, and umbrellas in variable positions from the rear of a vehicle.

Another objective is to provide a more comfortable fishing or tailgating experience.

Yet another objective is to enable the table and the pole holder attachment to swivel and height-adjust.

Yet another objective is to provide a carrying case for transporting the disassembled tailgate assembly.

Yet another objective is to provide a more stable fishing pole retention than a ground mounted pole holder.

Yet another objective is to fabricate the assembly to be rust proof.

These and other objectives, advantages and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The invention will now be described, by way of example, with reference to the accompanying drawings, in which:

FIG. 1 illustrates a perspective view of an exemplary vehicle tailgate assembly for retaining fishing rods and tailgate accessories hitched to the rear end of the vehicle, in accordance with an embodiment of the present invention;

FIG. 2 illustrates an exploded view of the vehicle tailgate assembly for retaining fishing rods and tailgate accessories arranged for assemblage, in accordance with an embodiment of the present invention;

FIG. 3 illustrates an exploded view of the vehicle tailgate assembly shown in FIG. 2 separated, in accordance with an embodiment of the present invention;

FIGS. 4A-4D illustrate views of an exemplary swiveling hitch, where FIG. 4A shows a perspective view of the swiveling hitch with round edge swivel plates, FIG. 4B shows a hitch plate of the swiveling hitch, FIG. 4C shows a pair of swivel plates and FIG. 4D shows a perspective view of the swiveling hitch with sharp edge swivel plates, in accordance with an embodiment of the present invention;

FIGS. 5A-5C illustrate views of an exemplary first extension bar, where FIG. 5A shows a perspective view of the first extension bar, FIG. 5B shows a free end of the first extension bar and FIG. 5C shows perspective view of the first extension bar in an alternate configuration, in accordance with an embodiment of the present invention;

FIGS. 6A-6C illustrate views of an exemplary supplementary extension bar, where FIG. 6A shows a perspective view of the supplementary extension bar, FIG. 6B shows a free end of the supplementary extension bar and FIG. 6C shows a perspective view of the supplementary extension bar in an alternate configuration, in accordance with an embodiment of the present invention;

FIGS. 7A-7F illustrate views of exemplary tee bar components, where FIG. 7A shows a perspective view of an exemplary short coupler, FIG. 7B shows an exemplary hitch plate for the tee bar, FIG. 7C shows an exemplary pole holder attachment extension bar, FIG. 7D shows an exemplary tee bar joined with the short coupler, FIG. 7E shows an alternate exemplary single piece tee bar, FIG. 7F shows an alternate exemplary pole holder attachment extension bar;

FIGS. 8A-8B illustrate views of an exemplary table, where FIG. 8A shows a top surface of the table, and FIG. 8B shows a bottom surface of the table comprising a pair of table retainers 311 mounted to the bottom surface of the table, in accordance with an embodiment of the present invention;

FIGS. 9A-9D illustrate views of an exemplary height adjustable leg, where FIG. 9A shows a first section of the height adjustable leg, and FIG. 9B shows a second section of the height adjustable leg, FIG. 9C shows an alternate exemplary configuration of a second section of the height adjustable leg, and FIG. 9D shows an alternate exemplary configuration of a first section of the height adjustable leg, in accordance with an embodiment of the present invention;

FIGS. 10A-10C illustrate views of an exemplary umbrella holder, where FIG. 10A shows a perspective view of the umbrella holder, FIG. 10B shows an exemplary square tube of the umbrella holder, and FIG. 10C shows an exemplary cylinder of the umbrella holder, in accordance with an embodiment of the present invention; and

FIG. 11 illustrates an exemplary adjustable and detachable gun rest pad to attach one of the pole holder plates for target practicing, in accordance with an embodiment of the present invention.

Like reference numerals refer to like parts throughout the various views of the drawings.

### DETAILED DESCRIPTION OF THE INVENTION

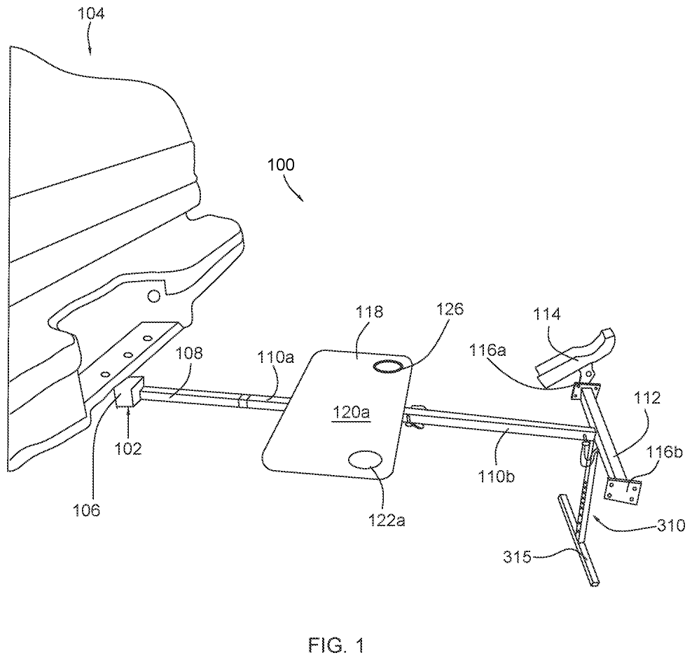

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

A vehicle tailgate assembly 100 for retaining fishing rods and tailgate accessories is referenced in FIGS. 1-11. The vehicle 104 tailgate assembly 100, hereafter “assembly 100” is a unique tailgating accessory that detachably couples to the rear of a vehicle 104 while retaining fishing rods and other tailgate-related accessories when in use. The assembly 100 is unique in that the capacity for easy manual adjustments to the position, orientation, length, and height of the components therein, which creates a more enjoyable and versatile tailgating experience.

As FIG. 1 references, the assembly 100 provides a unique arrangement of: a swiveling hitch 102, multiple length adjustable extension bars (108, 110a-b), a table 118, a height adjustable leg 310, a pivoting pole holder attachment 114, multiple cup holder 126s formed in the table 118, and an umbrella holder 1000 attachment. Further, the assembly 100 is operational while coupled to the rear of a vehicle 104 through the swiveling hitch 102. Such a swiveling hitch 102 enables rotation of the table 118 and pole holder attachment 114. At least one length adjustable extension bar (108, 110a-b) is easily added and removed along the length of the assembly 100 for easy length adjustments. This helps to vary the lateral separation distance between the rear of the vehicle 104 and the table 118 and pole holder attachment 114, during use, or transport. By increasing or decreasing the lateral separation distance, the vehicle 104 tailgate, or the rear door/hatchback of the vehicle 104 can be accessed more readily. The height and angle of inclination of the table 118, the fishing rod (not shown) are adjustable with a telescopic height adjustment leg 310 that secures to the bottom of the tee bar 112 of the assembly 100.

According to one aspect of the present invention, a vehicle tailgate assembly 100 wherein the assembly 100 comprises: a swiveling hitch 102, one or more length adjustable extension bars (108, 110a-b), an adjustable table 118 with multiple tailgate accessory retention holes 122a-b, an adjustable tee bar 112, one telescopic height adjustable support leg 310 detachably mounted to the tee bar 112 and at least one umbrella holder attachment 1000.

According to another aspect of the present invention, the tee bar 112 comprises a pair of adjustable pole holder extension bars 202a-b at least one pole holder attachment 114 pivotally and detachably coupled to the pole holder extension bars 202a-b, whereby the tee bar 112 is configured to attach to the length adjustable extension bar (108, 110a-b) pivotally and detachably in an orthogonal relationship.

According to another aspect of the present invention, a vehicle tailgate assembly 100, wherein the assembly 100 comprises: a swiveling hitch 102 configured to detachably coupling to a vehicle 104; a first extension bar 108 configured to pivotally and detachably attach to the swiveling hitch 102; at least one supplementary extension bar 110a-b configured to pivotally and detachably attach to the first extension bar 108; a tee bar 112 configured to pivotally and detachably attach to the supplementary extension bar 110a-b in an orthogonal relationship, wherein the tee bar 112 comprises a pair of adjustable pole holder extension bars 202a-b; at least one pole holder attachment 114 pivotally and detachably coupled to the pole holder extension bars 202a-b; at least one adjustable table 118 configured to detachably attach to the at least one supplementary extension bar 110a-b; one telescopic height adjustable support leg 310 detachably mounted to the tee bar 112 and at least one umbrella holder 1000 configured to removably attach to the assembly 100.

According to another aspect of the present invention, the table 118 is provided with a linear measurement indicia 800, multiple accessory retention holes 122a-b and one or more cup holders 126.

According to another aspect of the present invention, the swiveling hitch 102 comprising a first end 316a and a second end 316b, the first end 316a is configured to detachably couple to a hitch receiver 106 of the vehicle 104 and the second end 316b comprising a pair of swivel plates 302a-b.

According to another aspect of the present invention, addition, and removal of the at least one supplementary extension bar 110a-b enables length adjustment of the assembly 100.

According to another aspect of the present invention, the adjustable pole holder extension bars 202a-b comprises a pair of pole holder plates 116a-b joined to their free ends to detachably attach at least one pole holder attachment 114 that is configured to pivotally retain one or more pole (not shown) about the horizontal axis of the tee bar 112.

According to another aspect of the present invention, the table 118 comprises a pair of table retainers 311 that are configured to detachably mount on to the extension bars (108, 110a, 110b) at a desired position along the length of the vehicle tailgate assembly 100.

According to yet another aspect of the present invention, a vehicle tailgate assembly 100 for retaining fishing rods and tailgate accessories, the assembly 100 comprising: a swiveling hitch 102, wherein the swiveling hitch comprising a first end 316a and a second end 316b, the first end 316a is configured with a hitch hole 318 to enable passage of a fastening pin to detachably couple to a vehicle hitch receiver 106 of a vehicle 104 and the second end 316b comprising a pair of swivel plates 302a-b attached to a hitch plate 300; a first extension bar 108, wherein the first extension bar 108 is configured to pivotally and detachably attach to the pair of swivel plates 302a-b; at least one supplementary extension bar 110a-b, wherein the supplementary extension bar 110a-b is configured to pivotally and detachably attach to the first extension bar 108 or the subsequent supplementary extension bar 110a Or 110b in a collinear relationship, whereby the addition and removal of the at least one supplementary extension bar 110a-b enables length adjustment of the assembly; a tee bar 112, wherein the tee bar 112 comprises a pair of adjustable pole holder extension bars 202a-b having a pair of pole holder plates 116a-b joined to their free ends, whereby the tee bar 112 is configured to pivotally and detachably attach to the supplementary extension bar 110a-b in an orthogonal relationship, while the adjustable pole holder extension bars 202a-b allows width adjustment of the assembly 100; at least one pole holder attachment 114 detachably coupled to each of the pole holder plate 116a-b, the pole holder attachment 114 is configured to pivotally retain one or more pole (not shown) about the horizontal axis of the tee bar 112; at least one adjustable table 118 detachably attached to the at least one supplementary extension bar 110a-b or the tee bar 112, wherein the table 118 comprises a top surface 120a defining a linear measurement indicia 800 and multiple accessory retention holes 122a-b, table retainers 311 that are configured to detachably mount on to the extension bars (108, 110a, 110b) at a desired position along the length of the vehicle tailgate assembly 100; a height adjustable telescopic leg 310 comprises a first section 312a that is configured to be telescopically arranged with the second section 312b allowing quick height adjustment of assembly 100, further the leg 310 comprises a leg stabilizer 315 to stabilize the height of the adjustable leg 310 to facilitate proper engagement with the ground; at least one cup holder 126 configured to removably fit into at least one of the accessory retention holes 122a-b; and at least one umbrella holder 1000 configured to removably attach to the first extension bar 108 or the supplementary extension bar 110a-b or tee bar 112.

According to yet another aspect of the present invention, the swiveling hitch 102 allows pivotal movement of the table 118 to retain a fishing pole attached to the pole holder attachment 114 at a desired angle and height.

According to another aspect of the present invention, the table, and the tee bar 112 comprise magnetic strips operable to retain fishing hook and tailgate accessories.

According to yet another aspect of the present invention, the pivotable configuration of the pole holder attachment 114 enables the pole to pivot up to 90 degrees.

According to another aspect of the present invention, the first extension bar 108 having a pair of free ends 316a-b that forms a receiving aperture 318 and a pair of lanyard eyes 302a-b to receive a lanyard pin.

According to yet another aspect of the present invention, the lanyard pin includes a 6-12″ cable with an eye at one end and a loop for receiving a detention pin at the other end.

According to yet another aspect of the present invention, the assembly 100 is fabricated from anodized aluminum.

According to yet another aspect of the present invention, the linear measurement indicia 800 comprises a 24″ ruler.

According to another aspect of the present invention, the assembly further comprises one or more coupler (600, 700) to facilitate quick attachment and detachment of the extension bars (108, 110a-b) and the tee bar 112 to the assembly 100.

According to yet another aspect of the present invention, the umbrella holder 1000 comprises a square tube 1002 and a cylinder 1004 welded together to detachably attach the umbrella holder 1000 to the assembly 100 while allowing to hold an umbrella.

According to yet another aspect of the present invention, the assembly 100 further comprising a long coupler 600 configured to join the pair of supplemental extensions bars 110a-b.

According to yet another aspect of the present invention, the pole comprises a fishing pole (not shown).

In another aspect, the top surface 120a of the table 118 comprises a space for logo 313.

In another aspect, a long coupler 600 is configured to join the pair of supplemental extensions bars 110a-b.

In another aspect, a short coupler 700 is configured to join the tee bar 112 with the supplemental extensions bars 110a-b.

In another aspect, a short coupler 700 is joined telescopic height adjustable support leg 310 to detachably attach the support leg 310 with the supplemental extensions bars 110a-b.

In another aspect, a short coupler 700 is joined with a stabilizer bar 315 to detachably attach the stabilizer bar 315 to the telescopic height adjustable support leg 310.

In another aspect, one or more single end snap button 900 are mounted to the swiveling hitch 102, the first extension bar 108, at least one supplementary extension bar 110a-b, the tee bar 112, the at least one pole holder attachment 114 and the height adjustable leg 310, pole holder extension bars 202a-b, long coupler 600, short coupler 700 or any combination thereof to allow their quick attachment, detachment, and adjustment at a desired position.

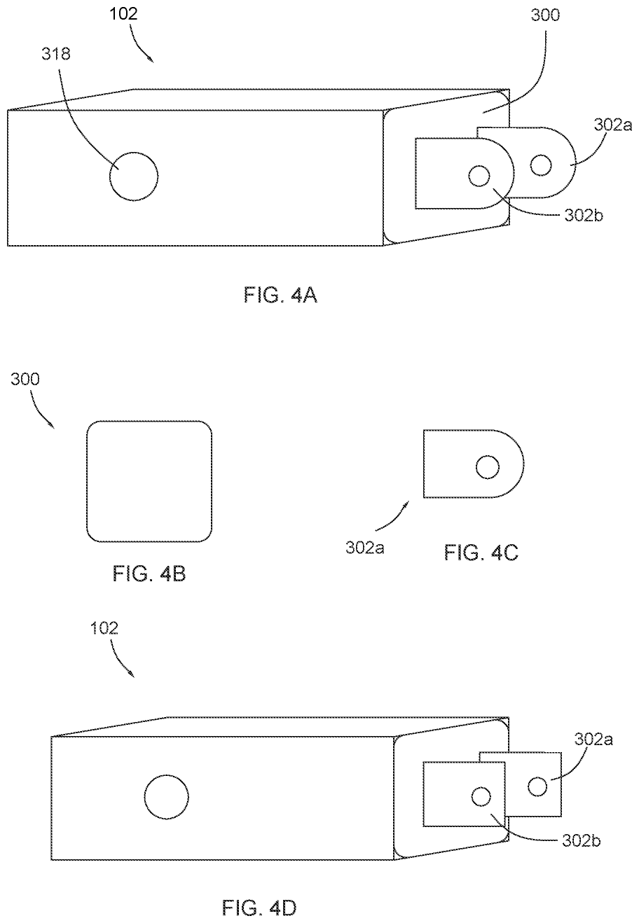

FIG. 1 illustrates a perspective view of the assembly 100 hitched to the rear end of a vehicle 104. As shown, the assembly 100 is configured to be assembled and used, when the vehicle 104 is in stationary mode whereby the pole holder attachment 114, table 118, and other tailgating related accessories are utilized. As FIG. 3 shows, the assembly 100 comprises a swiveling hitch 102, which is adapted for detachably coupling to a vehicle hitch receiver 106 of a vehicle 104. The swiveling hitch 102 is unique in that it swivels, or adjusts along a horizontal plane, in relation to the vehicle 104.

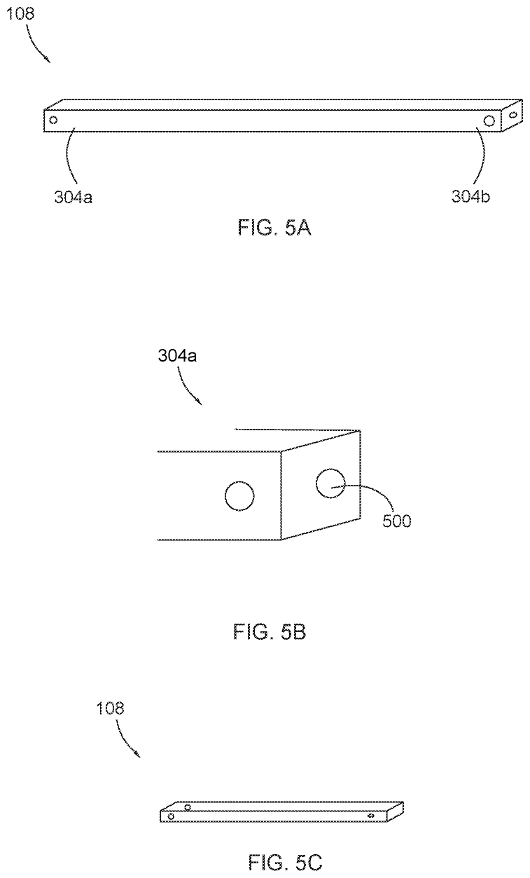

Looking at FIG. 4A, the swiveling hitch 102 comprises a first end 316a and an opposing second end 316b. The first end 316a inserts into the vehicle hitch receiver 106. Additionally, the first end 316a forms a pair of aligned hitch hole 318 that is configured to enable passage of a fastening pin for secure and detachable attachment to the vehicle hitch receiver 106. In this manner, the hitch 102 detachably attaches to the vehicle hitch receiver 106. The fastening pin can be inserted or removed from the hitch holes 318 to enable the detachable attachment of the swiveling hitch 102 from the vehicle hitch receiver 106.

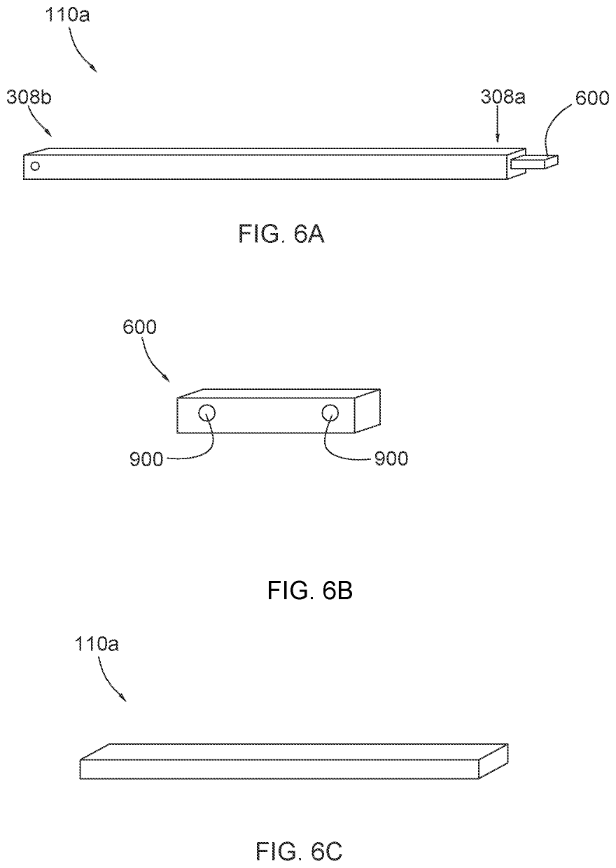

Looking now at FIG. 4B, the swiveling hitch 102 further comprising a hitch plate 300 joined to the second end 316b. The swiveling hitch 102 further comprising a pair of swivel plates 302a-b (See FIG. 4C) that are rotatably joined with the second end of the hitch body 316b. The swivel plates 302a-b are adjustable along a horizontal plane. As discussed below, rotation of the swiveling hitch 102 allows the entirety of extension bars, table 118, and pole holder attachment 114 to rotate in conjunction to adjust angle and height of the assembly 100. This can be useful for adjusting to uneven terrain or manipulating the assembly 100 in a tight position. The pair of swivel plates 302a-b may have rounded free ends as shown in FIG. 4C or the pair of swivel plates 302a-b may have sharp free ends as shown in FIG. 4D. The holes on the swivel plates 302a-b are configured to detachably attach a first extension bar 108 (FIG. 5A).

According to another embodiment as shown in FIG. 5A, along the longitudinal axis of the assembly 100, a first extension bar 108 having a pair of free ends 304a-b, wherein the free end 304a forms a pair of receiving aperture 500 that are configured to align with a pair of lanyard eyes that couples to the pair of swivel plates 302a-b (See FIG. 4A, 4D). The receiving aperture 500 is sized and dimensioned to mate with the swivel plates 302a-b (See FIG. 5B). The swivel plates 302a-b can simply lock into the receiving aperture with correspondingly shaped cavities. In this capacity, the first extension bar 108 swivels, about the swiveling hitch 102, or adjust along a horizontal plane. The free end 304b of first extension bar 108 forms a pair of receiving aperture 500 that are configured to align with a supplementary extension bar 110a-b. According to another embodiment as shown in FIG. 5C, the free end 304b of first extension bar 108 may comprise a bottom receiving aperture that are configured to quickly align a supplementary extension bar 110a-b.

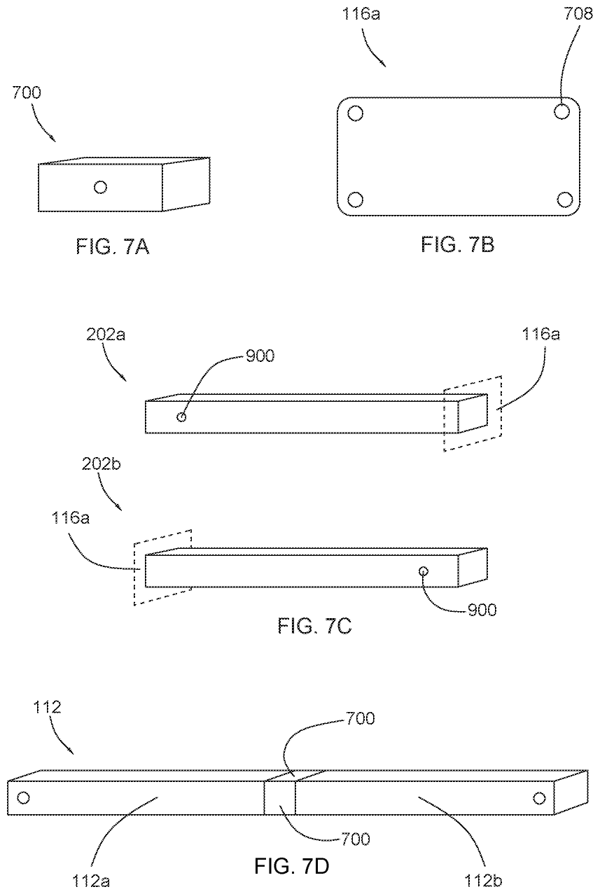

Turning now to FIG. 6A, at least one supplementary extension bar 110a, 110b joins to the first extension bar 108, or to an adjoining supplementary extension bar 110a, 110b in a collinear relationship along the length of the assembly 100. Similar to the first extension bar 108, the at least one supplementary extension bar 110a, 110b has a pair of free ends that are configured to have a receiving aperture to fasten the supplementary extension bar 110a, 110b to the first extension bar 108 by coupling a long coupler 600 to the corresponding aligned holes. According to another embodiment the opposing free end forms a tab that projects therefrom, wherein the tab is sized and dimensioned to mate with the receiving aperture of the first extension bar 108. In this arrangement, and linear formation forms from the swiveling hitch 102, to the first extension bar 108, and finally to any number of the supplementary extension bars 110a, 110b. The lanyards may include a 6-12″ cable with an eye at one end and a loop for receiving a detention pin at the other. The lanyards are riveted to each part requiring a detention pin to not lose the pins.

Further according to another exemplary embodiment as shown in 6C the supplementary extension bar 110a, 110b is preferably a square bar without any aperture or tab, which can be detachably attached to the first extension bar 108 or to the subsequent supplementary bar 110b or tee bar 112 by using a long coupler 600 as shown in FIG. 6B.

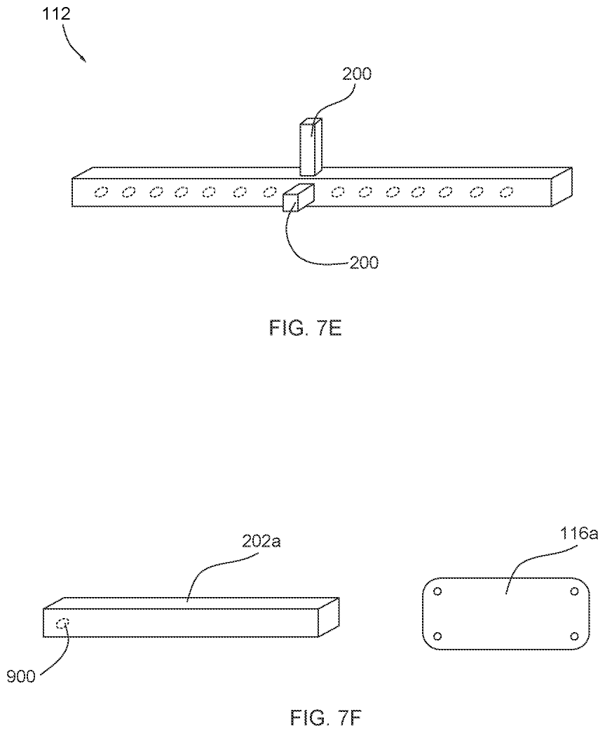

Continuing along the length of the assembly 100 is a tee bar 112 that forms the terminus element of the assembly 100. Looking again at FIG. 3, the tee bar 112 joins with the supplementary extension bar 110a, 110b in an orthogonal relationship. In one embodiment, the tee bar 112 defines a horizontal axis. As shown in FIG. 7A, a short coupler 700 is welded at the center to get detachably connect to the extension bars (108, 110a-b). FIG. 7D shows the sections 112a-b of the tee bar 112 connected with the short coupler 700. The tee bar 112 has a pair of free ends, and a central tab 200 projecting from a midpoint there along. In some embodiments, the assembly 100 also includes a pair of pole holder plates 116a-b joined to the free ends of the tee bar 112 (FIG. 7B).

In some embodiments, a pair of pole holder extension bars 202a-b, shown in FIG. 7C, can be used to increase the lateral length of the tee bar 112. The pole holder extension bars 202a, 202b can be positioned between the two sections 112a-b of the tee bar 112. This creates greater lateral separation distance between a pair of pole holder attachment bars 202a-b. The pole holder extension bar 202a-b can be 10″ long and segregated into incremental fastening holes. For example, 8¼″, 7¾″, 6¼″, 5¼″, 4¾″, 3¼″, 2¼″, 1¼″. In one possible embodiment, end plates 116a, 116b can be welded to each end of the pole holder extension bar 202a-b. Four corner ¾″ fastening holes 708 can form 5/16″ in from the corners of the end plate 116a-b.

According to another exemplary embodiment as shown in FIG. 7E, the tee bar 112 is a single bar having a central tab 200 welded to the center of the tee bar 112. The bottom portion of the tee bar 112 is provided with incremental fastening holes, for example 7 holes, at 1″, 2.25″, 3.5″, 4.75″, 6″, 7.25″, 8.5″ from both end of the bar 112 to adjust the lateral separation distance between a pair of pole holder attachment bars 202a-b. Further magnetic strips are attached on both sides of the tee bar 112 to hold tailgate accessories like fishing hooks or the like.

According to another exemplary embodiment as shown in FIG. 7F, the pole holder attachment bars 202a-b are 10″ long bars having single end snap button 900 installed at the inner end to facilitate quick adjustment of the lateral separation distance of the pole holder attachment bars 202a-b, further a pair of pole holder plates 116a-b (FIG. 7B) joined to the free ends of the tee bar 112 to facilitate detachable and pivotable attachment of at least one pole holder attachment 114 (shown in FIG. 1).

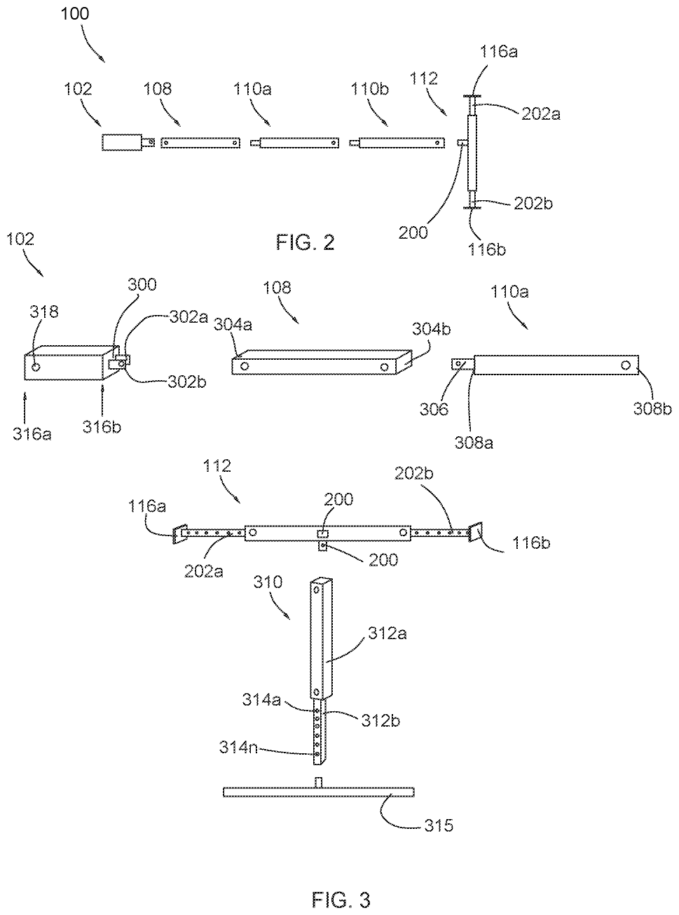

Looking again at FIG. 2, the assembly 100 provides a pole holder attachment 114 (shown in FIG. 1) that detachably couples to each pole holder plate 116a-b. The pole holder attachment 114 is configured to retain a pole (not shown). In some embodiments, the pole may include a fishing pole, or rod. The pole holder attachment 114 is also configured to pivot about the horizontal axis of the tee bar 112. Thus, as illustrated in FIG. 1, the pole holder attachment 114 has a fulcrum about which a couple of receptacles pivot in a forward and backward direction. Those skilled in the art will recognize that fishing involves throwing out a line from the rod and then pulling back to real in bait with/without fish. In this manner, a user can leave multiple fishing poles unattended on the pole holder attachment 114. If a fish takes the bait, the fishing pole pivots forward to a predetermined depth to indicate action.

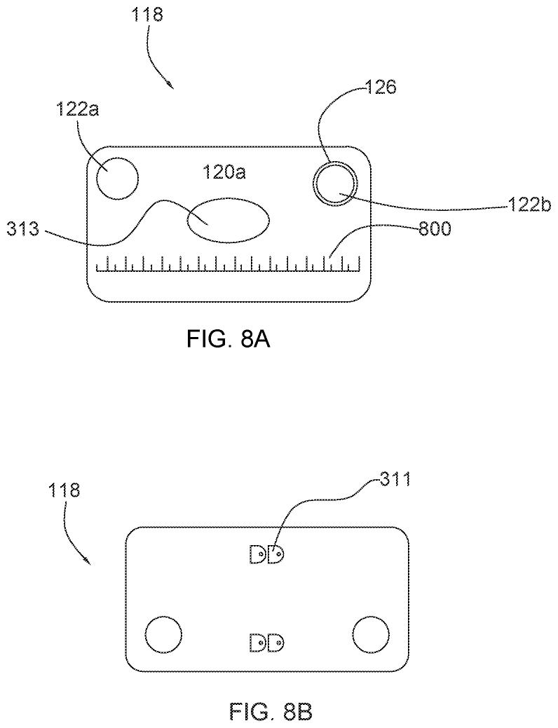

Because the present disclosure relates to tailgating, the assembly 100 uniquely provides a table 118 that fastens to the at least one supplementary extension bar 110a, 110b, or at least to a portion of the tee bar 112. As FIG. 8A shows, the table 118 has a top surface 120a oriented upwardly, and a bottom surface 120b oriented toward the ground. In any case, the table 118 is used for eating, drinking, measuring captured fish, and generally providing a supportive surface near the rear of the vehicle 104.

In one possible embodiment as shown in FIG. 8A, the top surface 120a defines a linear measurement indicia 800. This may include a 24″ ruler that is engraved or adhered or drawn onto the top surface 120a. This can be useful for measuring the length of a fish. The bottom surface 120b of the table 118 defines fastening holes. The top surface 120a of the table 118 further comprises a space for logo 313. In other embodiments, the table 118 defines multiple accessory retention holes 122a, 122b. As discussed below, the retention holes can receive one or more cup holders 126s or the like.

In one possible embodiment, adhesive applied magnetic strips are available on each side of table 112, facing the vehicle. The magnetic strips can be 6″×1″ located on each side of the tee to facilitate easy and quick attachment of fishing hooks, tailgate accessories or the like.

Further according to another exemplary embodiment of the present invention, as shown in FIG. 8B, at the center of each side of the bottom surface 120b of the table 118 comprises a pair of table retainers 311 to facilitate quick removal and mounting of the table 118 on to the top surface of extension bars (108, 110a, 110b) at a desired position along the length of the vehicle tailgate assembly 100, further a height adjustable leg 310 allows to adjust the height of the tailgate assembly 100 thereby allowing the table 118 to be raised or lowered for accommodating different terrains, chair heights, or heights of people or as per the need.

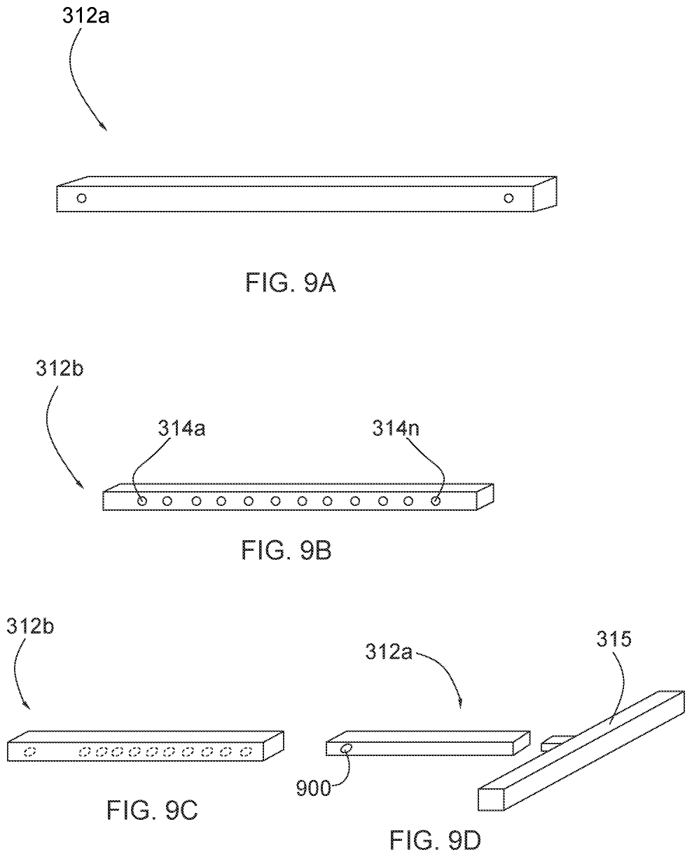

Looking now at FIG. 9A, the assembly 100 provides a height adjustable leg 310 attached to the tee bar 112. The height adjustable leg 310 comprises a first section 312a and a second section 312b that are arranged in a telescopic relationship. Each section 312a and 312b has leg retention holes 314a-n that can be aligned and secured together with a fastening pin to hold the height adjustable leg 310 at a desired height. FIG. 9B shows the leg retentions holes 314a-n disposed in a spaced-apart linear configuration. This allows the assembly 100 to be raised or lowered for accommodating different terrains, chair heights, or heights of people or as per the need. In this manner, aligning the leg retention holes to receive a pin helps fasten the height adjustable leg 310 to position the assembly 100 at a desired height.

In some embodiments, as shown in FIG. 9C-D and FIG. 3, the height adjustable leg 310 comprises the first section 312a is a 14″ bar having a single end snap button 900 installed at its top end, the second section 312b comprises multiple leg retention holes 314a-n spaced at 1.25″ from each other, wherein the second section 312b is configured to be telescopically arranged with the first section 312a of the height adjustable leg 310 at desired height while the single end snap button 900 of section 312a detachably locks to the leg retention holes 314a-n of section 312a at desired height. Further at both ends of the first section 312a comprises single end snap button 900 installed in the holes at both ends to quickly attach the first section 312a at top end and allows quick height adjustment of assembly 100 by locking the first section 312a with the desired point at the leg retention holes 314a-n on the second section 312b. Further a leg stabilizer 315 is attached to the bottom end of the first section 312a allowing to stabilize the height adjustable leg 310 on the surface while it facilitates proper engagement with the ground. Further a short coupler 700 is joined with a stabilizer bar 315 to detachably attach the stabilizer bar 315 to the telescopic support leg 310.

In some embodiments, as shown in FIG. 1, a cup holder 126 is configured to removably fit into at least one of the accessory retention holes 122a, 122b that form in the table 118. Those skilled in the art will recognize that tailgating involves drinking and eating; and thereby a retainer such as a cup/glass holder 126 is useful.

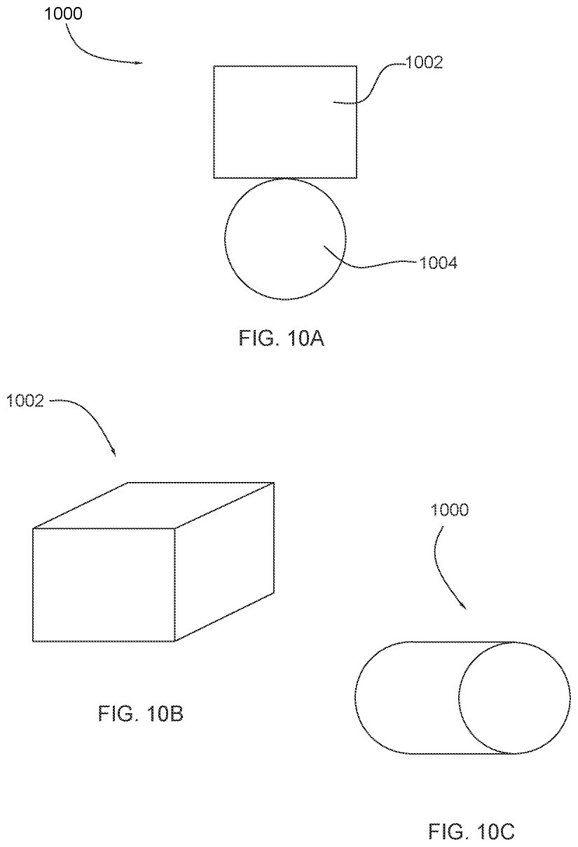

Turning now to FIG. 10A, the assembly 100 also provides an umbrella holder 1000, which helps retain the lower handle of an umbrella. The umbrella holder 1000 is designed to slide over any of the extensions, as to allow umbrella multiple locations for convenience of user. In some embodiments, the umbrella holder 1000 comprises a square tube 1002 and a cylinder 1004 welded together (See FIGS. 10B-10C), such that the umbrella holder gets attached to the assembly 100 via the square tube 1002 while the cylinder 1004 of size 2-5″ allows to hold the umbrella at the desired position. Other configurations can be used depending on the type of handle in the umbrella. In one non-limiting embodiment, the umbrella holder 1000 is like a table umbrella with a 1″-1½″ pole to drop in holder positioned at side of extension piece.

According to another embodiment of the present invention the assembly 100 is packed as a kit box for easy transportability and storage of the assembly 100 when not in use, wherein the assembly 100 comprises a swiveling hitch 102, a first extension bar 108, at least one supplementary extension bar 110a-b, a tee bar 112, a pair of adjustable pole holder extension bars 202a-b having a pair of pole holder plates 116a-b, at least one pivotable pole holder attachment 114, a height adjustable table 118, at least one cup holder 126, at least one umbrella holder 1000, an adjustable and detachable gun rest pad 113, a plurality of fastening pins, adhesive coated magnetic strips (not shown), adhesive coated linear measurement indicia 800 and other tailgate accessories.

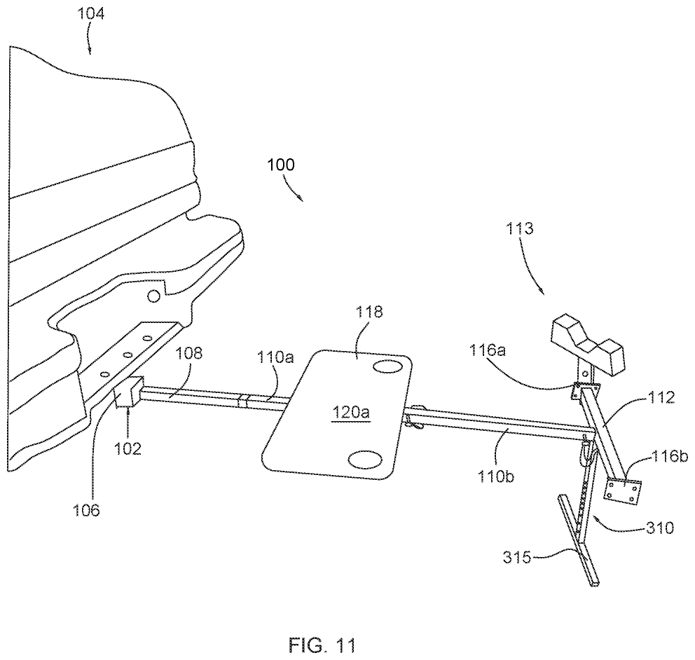

According to another embodiment of the present invention as shown in the FIG. 11, the assembly 100 allows to an adjustable and detachable gun rest pad 113 to attach one of the pole holder plates 116a-b for target practicing, further according to another embodiment, the gun rest pad 113 is configured to be mounted to the assembly in place of the tee bar 112. Similarly, the assembly 100 allows multiple applications without any limitation.

The assembly 100 allows to an adjustable and detachable gun rest pad 113 that is configured to either detachably attach to the one of the pole holder plates or to the at least one supplementary extension bar 110a-b.

The assembly 100 is unique in that the capacity for easy manual adjustments to the position, orientation, length, and height of the components therein, which creates a more enjoyable and versatile tailgating experience. Turning back to the swiveling hitch 102, the capacity to swivel, or adjust along a horizontal plane, allows the table 118 and the pole holder attachment 114 to rotate accordingly. Additionally, the addition and removal of the at least one supplementary extension bar 110a, 110b enables variance in the lateral separation distance between the rear of the vehicle 104 and the table 118. In other words, the distance between the table 118 and the rear of the vehicle 104 can be varied. Similarly, the distance between the pole holder attachment 114 and the rear of the vehicle 104 can also be varied. This capacity to adjust the table 118 and the pole holder attachment 114 can be useful for adapting to different vehicle 104s, greater number of users, and different terrains. In alternative embodiments, the capacity to increase lateral separation distance allows for adding multiple table 118s along the distance of the supplemental extension bars.

Those skilled in the art will appreciate that the assembly 100 is uniquely configured to detachably couple to the rear of a vehicle 104 while retaining fishing rods and other tailgate-related accessories and for other applications. The assembly 100 provides a unique arrangement of: a swiveling hitch 102, multiple length adjustable 118 extension bars, an adjustable table 118, a height adjustable leg 310, a pivoting pole holder attachment 114, multiple cup holder 126s formed in table 118, and an umbrella holder 1000 attachment. The assembly 100 couples to the rear of vehicle 104 through the swiveling hitch 102. The swiveling hitch 102 enables rotation of the table 118 and pole holder attachment 114. Length adjustable 118 extensions are easily added and removed along the longitudinal of the assembly 100 for length adjustments to vary the lateral separation distance between the rear of the vehicle 104 and the table 118 and pole holder attachment 114. The table 118 is adjustably mounted at a desired position along the length of the assembly 100. The cup holder 126 and umbrella holder 1000 are detachable.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A vehicle tailgate assembly, wherein the assembly comprises:
a swiveling hitch, configured to detachably coupling to a vehicle;
one or more length adjustable extension bars configured to pivotally and detachably attach to the swiveling hitch;
an adjustable tee bar configured to attach to the length adjustable extension bar pivotally and detachably in an orthogonal relationship;
one or more adjustable tables with multiple tailgate accessory retention holes;
one telescopic height adjustable support leg detachably mounted to the tee bar; and
at least one umbrella holder;
wherein the table and the umbrella holder are configured to detachably attach to the length adjustable extension bar.

2. The assembly of claim 1, wherein the tee bar comprises a pair of adjustable pole holder extension bars at least one pole holder attachment pivotally and detachably coupled to the pole holder extension bars.

3. A vehicle tailgate assembly, wherein the assembly comprises:
a swiveling hitch configured to detachably coupling to a vehicle;
a first extension bar configured to pivotally and detachably attach to the swiveling hitch;
at least one supplementary extension bar configured to attach to the first extension bar pivotally and detachably;
a tee bar configured to attach to the supplementary extension bar pivotally and detachably in an orthogonal relationship, wherein the tee bar comprises a pair of adjustable pole holder extension bars;
at least one pole holder attachment pivotally and detachably coupled to the pole holder extension bars;
at least one adjustable table configured to detachably attach to the at least one supplementary extension bar;
one telescopic height adjustable support leg detachably mounted to the tee bar; and
at least one umbrella holder configured to removably attach to the assembly.

4. The assembly of claim 3, wherein the table is provided with a linear measurement indicia, multiple accessory retention holes and one or more cup holders.

5. The assembly of claim 3, wherein the swiveling hitch comprising a first end and a second end, the first end is configured to detachably couple to a hitch receiver of the vehicle and the second end comprising a pair of swivel plates.

6. The assembly of claim 3, wherein addition and removal of the at least one supplementary extension bar enables length adjustment of the assembly.

7. The assembly of claim 3, wherein the adjustable pole holder extension bars comprise a pair of pole holder plates joined to their free ends to detachably attach at least one pole holder attachment that is configured to pivotally retain one or more pole about the horizontal axis of the tee bar.

8. The assembly of claim 3, wherein the table comprises a pair of table retainers that are configured to detachably attach on to the extension bars (108, 110a, 110b) at a desired position along the length of the vehicle tailgate assembly.

9. A vehicle tailgate assembly for retaining fishing rods and tailgate accessories, the assembly comprising:
a swiveling hitch, wherein the swiveling hitch comprising a first end and a second end, the first end is configured with a hitch hole to enable passage of a fastening pin to detachably couple to a vehicle hitch receiver of a vehicle and the second end comprising a pair of swivel plates attached to a hitch plate;
a first extension bar, wherein the first extension bar is configured to attach to the pair of swivel plates pivotally and detachably;
at least one supplementary extension bar, wherein the supplementary extension bar is configured to attach to the first extension bar or the subsequent supplementary extension bar pivotally and detachably in a collinear relationship, whereby the addition and removal of the at least one supplementary extension bar enables length adjustment of the assembly;
a tee bar, wherein the tee bar comprises a pair of adjustable pole holder extension bars having a pair of pole holder plates joined to their free ends, whereby the tee bar is configured to attach to the supplementary extension bar pivotally and detachably in an orthogonal relationship, while the adjustable pole holder extension bars allow width adjustment of the assembly;
at least one pole holder attachment detachably coupled to each of the pole holder plate, the pole holder attachment is configured to pivotally retain one or more pole about the horizontal axis of the tee bar;
at least one adjustable table detachably attached to the at least one supplementary extension bar or the tee bar, wherein the table comprises a top surface defining a linear measurement indicia and multiple accessory retention holes, further the table comprises table retainers that are configured to detachably mount on to the extension bars at a desired position along the length of the vehicle tailgate assembly;
a height adjustable telescopic leg comprises a first section that is configured to be telescopically arranged with the second section allowing quick height adjustment of assembly, further the leg comprises a leg stabilizer to stabilize the height of the adjustable leg to facilitate proper engagement with the ground;
at least one cup holder configured to removably fit into at least one of the accessory retention holes; and
at least one umbrella holder configured to removably attach to the extension bar or the supplementary extension bar.

10. The assembly of claim 9, wherein the swiveling hitch allows pivotal movement of the table to retain a fishing pole attached to the pole holder attachment at a desired angle and height.

11. The assembly of claim 9, wherein the table and the tee bar comprise magnetic strips operable to retain fishing hook and tailgate accessories.

12. The assembly of claim 9, wherein the pivotable configuration of the pole holder attachment enables the pole to pivot up to 90 degrees.

13. The assembly of claim 9, wherein the assembly is fabricated from anodized aluminum.

14. The assembly of claim 9, wherein the linear measurement indicia comprise a 24″ ruler.

15. The assembly of claim 9, wherein the assembly further comprises one or more coupler to facilitate quick attachment and detachment of the extension bars and the tee bar to the assembly.

16. The assembly of claim 9, wherein the umbrella holder comprises a square tube and a cylinder welded together to detachably attach the umbrella holder to the assembly while allowing to hold an umbrella.

17. The assembly of claim 9, further comprising a long coupler configured to join a pair of supplemental extensions bars.

18. The assembly of claim 9, wherein the pole comprises a fishing pole.

19. The assembly of claim 9, wherein one or more single end snap button is mounted to the swiveling hitch, the first extension bar, at least one supplementary extension bar, the tee bar, the at least one pole holder attachment and the height adjustable leg or any combination thereof to allow their quick attachment, detachment, and adjustment at a desired position.

20. The assembly of claim 9, wherein the assembly allows to an adjustable and detachable gun rest pad that is configured to either detachably attach to the one of the pole holder plates or to the at least one supplementary extension bar.
